(19) United States
(12) Patent Application Publication
(10) Pub. No.: US 2019/0377427 A1
(43) Pub. Date: Dec. 12, 2019

(54) ANALYSIS DEVICE FOR DETERMINING THE LENGTH OF A DETECTION PERIOD CONTRIBUTING TO A LATENCY TIME IN AN IMMERSIVE VIRTUAL REALITY SYSTEM

(71) Applicant: PSA AUTOMOBILES SA, Poissy (FR)

(72) Inventors: Matthieu MIKA, ST. GERMAIN DE LA GRANGE (FR); Christophe MION, JARVILLE LA MALGRANGE (FR)

(21) Appl. No.: 16/476,824

(22) PCT Filed: Jan. 25, 2018
(86) PCT No.: PCT/FR2018/050169

§ 371 Date: Jul. 9, 2019

(30) Foreign Application Priority Data
Feb. 1, 2017 (FR) 1750821

(51) Int. Cl. G06F 3/03; G06F 3/01; G06F 3/0346

(52) U.S. Cl. CPC G06F 3/0304; G06F 2203/012; G06F 3/0346; G06F 3/011

(57) ABSTRACT

The invention relates to a device (DA) performing analyses in an immersive virtual reality system, comprising a target (CD) secured to an object (O) that can move in a space (EP), and detection means (MD) for detecting the current position of said target (CD) in said space (EP) and delivering a first signal representing said current position. Said device (DA) comprises a sensor (CC) for generating a second signal when the object (O) reaches a known position in the space (EP), and analysis means (MA) that are coupled to the sensor (CC) and detection means (MD) and are used to determine a first time when a first signal representing said known detected position is received, and a second time when said second signal is received, and then to determine a temporal distance between the determined first and second receiving times.

### CROSS-REFERENCE TO RELATED APPLICATIONS

This application is the US National Stage under 35 USC § 371 of International Application No. PCT/FR2018/050169, filed 25 Jan. 2018 which claims priority to French Application No. 1750821 filed 1 Feb. 2017, both of which are incorporated herein by reference.

### BACKGROUND

The invention relates to immersive virtual reality systems.

In certain fields, such as vehicles, for example, of the automobile type, immersive virtual reality systems which are intended to immerse a user in a virtual environment are used. This immersion can be intended, for example, for teaching a user to move in a particular environment or to use objects and functions present in a particular environment, or for analyzing the behavior of a user in a particular environment, or also for observing a particular environment as a function of the position of a user with respect to the environment.

Such immersive (virtual reality) systems comprise in particular:
at least one target which can be secured to a user (or sometimes an object) and which is capable of moving in a predefined space,
detection means for detecting the current position of the target in the predefined space and delivering a signal representing the current position,
at least one display means, the task of which is to display on at least one screen installed in the predefined space images intended for this screen, and
at least one computer, the task of which is to define in real time for each associated screen three-dimensional images (optionally stereoscopic images) of a selected environment selected, as a function of the current position of the at least one target and the position of the associated screen in the predefined space.

In such an immersive system, there is generally a time difference or delay between the time when a user changes position and the time when the user sees the image resulting from his/her change in position on each screen. This time difference or delay, generally referred to as latency time, results not only from the signal and data processing time and from the signal, data and image transmission times, but also from the graphical rendering time of the computers and from the time difference between the time when the user finds himself/herself placed in a new position and the time when the detection means detects the target (and thus the user) in this new position.

In general, the longer this latency time is, the more discomfort the user experiences, possibly suffering nausea, vertigo or loss of balance. Therefore, it is important to find solutions which make it possible to reduce the latency time to a value that causes no discomfort to the user (that is to say a value approaching zero).

But before finding such solutions, the main contributors to the latency time have to be determined beforehand, including in particular the time difference between the time when the user finds himself/herself placed in a new position and the time when the detection means detects the target in this new position. However, today, no known solution exists for determining the time difference.

### SUMMARY

Therefore, the object of the invention is in particular to enable the determination of the time difference.

Therefore, for this purpose an analysis device is proposed which is intended to perform analyses in an immersive virtual reality system comprising at least one target that can be secured to an object that can move in a space, and detection means for detecting the current position of the target in the space and delivering a first signal representing the current position.

This analysis device comprises:
the object equipped with each target,
a sensor for generating a second signal when the object reaches a known position in the space, and
analysis means that is coupled to the sensor means and the detection means and which is used to determine a first time when a first signal representing the known detected position is received, and a second time when the second signal is received, and then to determine a time difference between the determined first and second receiving times.

In this way, it is possible to quantify the time difference between the effective arrival in a new position and the detection of this arrival can be quantified, which contributes significantly to the latency time of the immersive system.

The analysis device can comprise other features which can be considered individually or in combination, and in particular:
the analysis device can comprise a rail on which the object can move and which can be placed in the space so that the object can move to the known position;
   the analysis device can comprise a support on which the rail is firmly secured;
      the rail can be secured to the support so as to be inclined at a predefined acute angle with respect to a horizontal plane of the space and thus enable an automatic movement by gravity of the object with respect to the rail between a starting position and at least the known position;
         the analysis device can comprise electromagnetic means that is firmly installed on the rail and used for immobilizing the object in the starting position, when the electromagnetic means is put in a first state of magnetic attraction, and for releasing the object so that it can move to the known position, when it is put in a second, magnetically non-attracting, state;
         the electromagnetic means can be remotely controlled;
the object can be provided with an electric motor for inducing movement of the object when the analysis device is operating;
   the electric motor can be remotely controlled;
the sensor can be placed in the vicinity of the known position and generate the second signal when the object contacts the sensor.

Also proposed is an immersive virtual reality system comprising at least one target that can be secured to an object that can move in a space, detection means for detecting the current position of the target in the space and delivering a first signal representing the current position, and an analysis device of the type presented above.

### DESCRIPTION OF THE FIGURES

Other features and advantages of the analysis device and the immersive virtual reality system will become apparent upon review of the following detailed description and of the appended drawings in which:

FIG. 1 diagrammatically and functionally illustrates a portion of an immersive virtual reality system coupled to an exemplary embodiment of an analysis device, in which the object to be detected is placed in a starting position, and

FIG. 2 diagrammatically and functionally illustrates the portion of the immersive virtual reality system of FIG. 1 with the object to be detected of the analysis device placed in a known (final) position.

### DETAILED DESCRIPTION

An analysis device DA performs analyses in an immersive virtual reality system SI in order to determine a time difference (ect) which contributes to the latency time of the immersive virtual reality system.

Below, as a non-limiting example, it is considered that the immersive virtual reality system SI is intended to immerse a user in a virtual environment representing at least a portion of a vehicle, for example, an automobile (such as a car). But the invention is not limited to this type of virtual environment. In fact, it relates to any type of virtual environment.

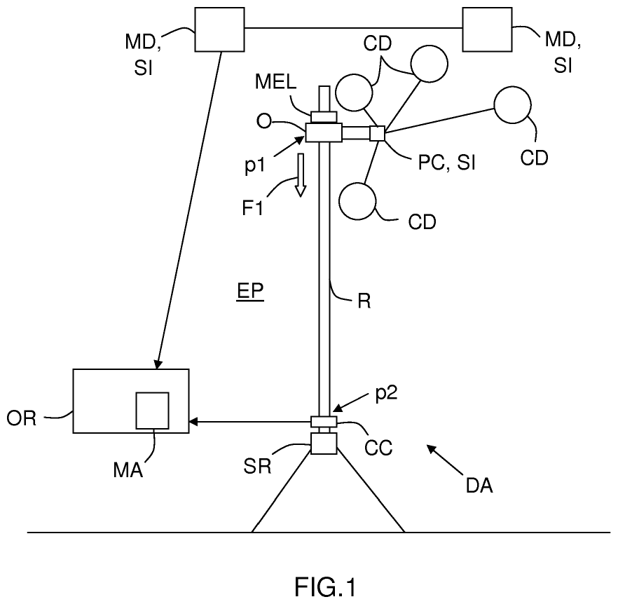

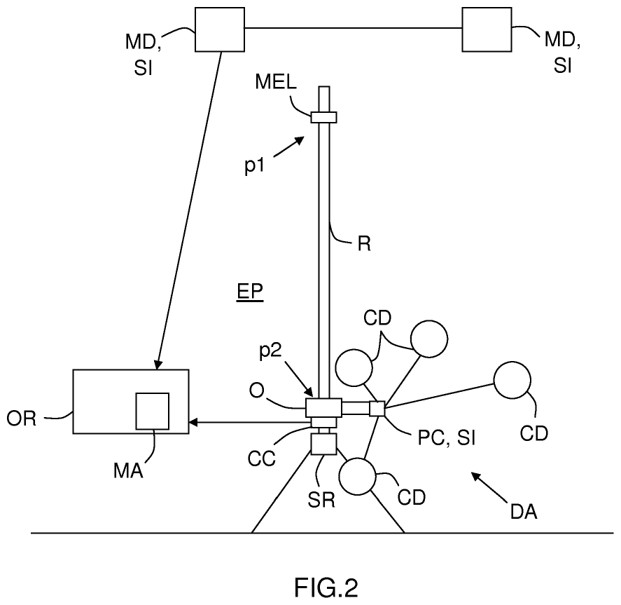

In FIGS. 1 and 2, a small portion of an immersive (virtual reality) system SI associated with a predefined space EP is represented diagrammatically, in which an exemplary embodiment of an analysis device DA is at least partially installed.

This small portion here comprises only a target carrier PC, secured here to an object O which is mobile and part of the analysis device DA, and detection means MD for detecting the current position of the targets CD of the target carrier PC in this predefined space EP and delivering a first signal s1 representing the current position of the object. It is noted that the target carrier PC here comprises four targets CD whose positions have to be determined at each measurement time by the detection means MD in order to deduce therefrom the current position of the object O at each measurement time. But it can comprise any number of targets CD, as long as the number is at least equal to one (1).

For example, the detection means MD here comprise two cameras each associated with an infrared photon emitter and capable of filming in infrared. Each emitter emits an infrared beam which will be reflected by the targets (or spheres) CD. Each camera records the images of the photons reflected by the targets (or spheres) CD and sends each recorded image to an image analysis computer which will deduce therefrom the position in the space of the target carrier PC at the time in question. However, the detection means MD could comprise more than two cameras.

It is recalled that, in addition to the detection means MD and the target carrier PC, an immersive (virtual reality) system SI also comprises at least one computer and at least one display means. The target carrier PC is intended to equip a user (or sometimes an object) capable of moving in the predefined space EP.

Each display means has the task of displaying on at least one screen installed in the predefined space EP images which are intended for this screen. It should be noted that each display means can comprise a screen and at least one projector, or a screen and an LCD panel with its associated electronic control means, for example.

The number of screens is generally between one and five. Each screen is installed in the predefined space EP. At least one computer ensures the definition in real time of three-dimensional images (optionally stereoscopic images) of the selected environment for at least one screen associated with it, as a function of the current position of the targets CD of the target carrier PC and of the position of the associated screen in the predefined space EP. In the presence of projector(s), each projector ensures the projection on the associated screen of three-dimensional images determined by the associated computer and intended for this screen.

As illustrated in a non-limiting manner in FIGS. 1 and 2, an analysis device DA comprises, in addition to the object O, a sensor CC and analysis means MA.

The object O is mobile so that it can move in the (predefined) space EP. In addition, as indicated above, the object must be equipped with at least one target CD which is possibly part of a target carrier PC (as in the non-limiting example illustrated in FIGS. 1 and 2).

The sensor CC is used to generate a second signal s2 when the object O reaches a known position p2 in the space EP.

For example and as illustrated in a non-limiting manner in FIGS. 1 and 2, this sensor CC can be placed in the vicinity of the known position p2 and generate the second signal s2 when the object O contacts it. For this purpose, the sensor can be, for example, of piezoelectric or capacitive or inductive type or of a mechanical type. However, in an alternative embodiment, the detection could occur without contact (and thus remotely), for example, by the interruption of a light beam passing through the known position p2.

The analysis means MA is coupled to the sensor CC and to the detection means MD. The analysis means determines a first time i1 when a first signal s1 representing the detected known position p2 is received, a second time i2 when the second signal s2 (generated by the sensor CC) is received, and the time difference (ect) between the first ii and second i2 determined reception times (or ect=i2−i1).

It should be understood that the known position p2 is used as reference position with respect to which the analysis means MA determines the time difference (ect) between the time i2 when the object O (which embodies a user moving in the space EP) finds itself placed in a “new position” (here p2), and the time i1 when the detection means MD detects the target(s) CD (and thus the object O) in this new position (here p2). It is recalled that this time difference (ect) is particularly useful to know due to the fact that it significantly contributes to the latency time of the immersive system SI, which one moreover wishes to reduce.

For example, when the analysis means MA receives at a time a first signal s1 representing the detected known position p2, it registers this time as first time i1, and when it receives at a time a second signal s2, it records this time as second time i2.

In the example illustrated in a non-limiting manner in FIGS. 1 and 2, the analysis means MA is part of a computer OR which is coupled (directly or indirectly) to the sensor CC and to the detection means MD of the immersive system SI. However, this is not necessary. In fact, the analysis means could constitute electronic equipment (comprising, for example, an oscilloscope and an electronic signal analysis circuit) coupled (directly or indirectly) to the sensor CC and to the detection means MD of the immersive system SI. Consequently, the analysis means MA can be implemented in the form of software modules or in the form of a combination of electronic circuits (or “hardware”) and software modules.

The movement of the object O can occur in different manners.

Thus, the analysis device DA can comprise, for example, a rail R on which the object O can move and which can be placed in the space EP so that the object O can move to the known position p2. In this case, the movement of the object O is constrained. It should be noted that this rail R can have a single axis, which may have but does not have to have a circular cross section.

For example, as illustrated in a non-limiting manner in FIGS. 1 and 2, the analysis device DA can also comprise a support SR on which the rail R is firmly secured.

Such a support SR can be intended, for example, to be put on the ground in the space EP. Thus, it can enable a placement of rail R in a position parallel to the ground or inclined by a predefined acute angle with respect to the ground and thus with respect to a horizontal plane of the space EP (as illustrated in a non-limiting manner in FIGS. 1 and 2).

In the first (parallel) alternative, for the object O to move from a starting position to the known position p2, either it must receive an initial impulse by a person or it must be provided with an electric motor preferably with remote controllable operation (for example, by radio waves).

In the second (inclined) alternative, the movement of the object O with respect to the rail R can occur automatically by gravity between a starting position p1 (illustrated in FIG. 1) and at least the known position p2 (illustrated in FIG. 2). In other words, the movement results from the falling of the object O along the rail R (along the arrow F1 of FIG. 1).

It should be noted that in the example illustrated in a non-limiting manner in FIGS. 1 and 2, the inclination angle of the rail R with respect to the ground (here horizontal) is equal to 90°. This makes it possible to use a simple support SR such as a tripod, for example. However, this angle could be less than 90°, and, for example, it could be equal to 450 or 60°.

It should also be noted that, as illustrated in a non-limiting manner in FIGS. 1 and 2, in the second alternative (inclination), the analysis device DA can comprise electromagnetic means MEL firmly installed on the rail R in the vicinity of the starting position p1. The electromagnetic means MEL, on the one hand, can immobilize the object O in its starting position p1 when it is put in a first state of magnetic attraction, and, on the other hand, it can release the object O so that it can move to the known position p2, when it is put in a second magnetically non-attracting state. These electromagnetic means MEL can be arranged, for example, in the form of an electromagnet which is magnetically attractive when supplied with current, and magnetically non-attractive when not supplied with current. It should be noted that if the electromagnet is sufficiently powerful, it can also be used when it is supplied with current to automatically raise the object O from the known position p2 back to its starting position p1.

Such electromagnetic means MEL, for example, can be remotely controlled, for example, by radio waves. This control can occur via a computer coupled to the electromagnet means MEL, such as the computer (OR) which can comprise the analysis means MA, or it can occur via a remote control. In fact, this allows a user to trigger the fall of the object O remotely without any risk interfering with the continuation of detection of the object in its fall by the detection means MD.

It should be noted that in the example illustrated in a non-limiting manner in FIGS. 1 and 2, the sensor CC is firmly secured to the rail R just below the known position p2, since the sensor CC ensures detection by contact.

It should also be noted that the movement of the object O is not necessarily constrained, for example, due to the fact that it is secured to a rail R. In fact, in an alternative embodiment, one can consider arranging the object O so that it rolls on the ground of the space EP. For example, it can comprise wheels which are optionally driven in rotation by an electric motor. In the absence of an electric motor, the object O moves from a starting position to the known position p2 by means of an initial impulse supplied by a person. In the presence of an electric motor, the startup of operation of the motor induces the movement of the object O from a starting position to the known position p2. This operation is then preferably remotely controllable (for example, by radio waves). This control can occur via a computer coupled to the object O, such as the computer (OR) which can comprise the analysis means MA, or it can occur via remote control.

The object O can have a numerous arrangements depending in particular on the manner in which it should move. For example, it can be implemented in the form of a part (optionally metallic) having a general parallelepiped form, either with a groove or coupling means suitable for its movement along a rail R, or with wheels. The movements can also occur on an air cushion, for example.

1. An analysis device for an immersive virtual reality system comprising at least one target that can be secured to an object that can move in a space, and detection means for detecting the current position of said target in said space and delivering a first signal representing said current position, said device comprising:
i) said object equipped with said target,
ii) a sensor for generating a second signal when said object reaches a known position in said space,
iii) analysis means that is which receives signals from said sensor and detection means and which is used to determine a first time when a first signal representing said known detected position is received, and a second time when said second signal is received, and then to determine a time difference between said determined first and second receiving times, and
iv) a rail on which said object can move and which can be placed in said space in such a manner that said object can move to said known position.

2. The device according to claim 1, wherein said device comprises a support on which said rail is firmly secured.

3. The device according to claim 2, wherein said rail is secured to said support so as to be inclined by a predefined acute angle with respect to a horizontal plane of said space and thus enable an automatic movement by gravity of said object with respect to said rail between a starting position and at least said known position.

4. The device according to claim 3, wherein said device comprises electromagnetic means that is installed on said rail and used i) for immobilizing said object in said starting position when said electromagnetic means is in a first state of magnetic attraction, and ii) for releasing said object so that said object can move to said known position when said electromagnetic means is in a second magnetically non-attracting state.

5. The device according to claim 4, wherein said electromagnetic means is remotely controllable.

6. The device according to claim 1, wherein said object is provided with an electric motor for inducing movement of said object when said electric motor is operating.

7. The device according to claim 6, wherein said electric motor is remotely controllable.

8. The device according to claim 1, wherein said sensor is in the vicinity of said known position and generates said second signal when said object contacts said sensor.

9. An immersive virtual reality system comprising at least one target that can be secured to an object that can move in a space, and detection means for detecting the current position of said target in said space and delivering a first signal representing said current position, wherein said immersive virtual reality system includes an analysis device according to claim 1.
